(19) United States
(12) Patent Application Publication
(10) Pub. No.: US 2013/0304512 A1
(43) Pub. Date: Nov. 14, 2013

(54) SYSTEM AND METHOD FOR SHARING DATA IN A CLINICAL NETWORK ENVIRONMENT

(71) Applicant: Net.Orange, Inc., Dallas, TX (US)

(72) Inventors: Ravi Seshadri, Plano, TX (US); Vasu Rangadass, Arlington, TX (US)

(21) Appl. No.: 13/943,769

(22) Filed: Jul. 16, 2013

Related U.S. Application Data
(63) Continuation-in-part of application No. 12/536,060, filed on Aug. 5, 2009.
Application No. 12/536,060 is a continuation-in-part of application No. 12/816,804, filed on Jun. 16, 2010.
Application No. 12/816,804 is a continuation-in-part of application No. 12/536,060, filed on Aug. 5, 2009.
(60) Provisional application No. 61/086,344, filed on Aug. 5, 2008.
(60) Provisional application No. 61/086,344, filed on Aug. 5, 2008.

(51) Int. Cl. G06F 19/00

(52) U.S. Cl. CPC G06F 19/322
USPC 705/3

(57) ABSTRACT

A method for sharing data in a clinical network environment is provided in one example embodiment and includes associating a participant with a community in a clinical network environment comprising patients, medical providers, and payors, determining participant access privileges to data in a database, and providing access to the data according to a predetermined mode of sharing associated with the data. The data includes medical data, financial data and operations data associated with patients, medical providers and payors. The predetermined mode of sharing can include pessimistic mode, optimistic mode, or opportunistic mode. According to the optimistic mode, all data in the database is accessible to all participants in the community. According to the pessimistic mode, selected data in the database is accessible to all participants in the community. According to the opportunistic mode, selected customized data in the database is accessible to specific participants in the community.

### CROSS-REFERENCE TO RELATED APPLICATION

This Application is a continuation-in-part and claims the benefit of priority under 35 U.S.C. §120 to U.S. application Ser. No. 12/536,060, entitled “Operating System” filed Aug. 5, 2009, which application claims the benefit of priority to U.S. Provisional Application Ser. No. 61/086,344, entitled “Operating System” filed Aug. 5, 2008. This Application is also a continuation-in-part and claims the benefit of priority under 35 U.S. §120 to U.S. application Ser. No. 12/816,804, entitled “Operating System” filed Jun. 16, 2010, which application is a continuation-in-part of Ser. No. 12/536,060, entitled “Operating System” filed Aug. 5, 2009, which application in turn claims the benefit of priority to U.S. Provisional Patent Application Ser. No. 61/086,344, entitled “Operating System” filed Aug. 5, 2008. The disclosures of the prior applications are considered part of, and are incorporated by reference in their entireties in, the disclosure of this Application.

### TECHNICAL FIELD

This disclosure relates in general to the field of healthcare systems and, more particularly, to a system and a method for sharing data in a clinical network environment.

### BACKGROUND

Paper-based medical records have been in existence for centuries and are being gradually replaced by computer-based records in modern healthcare systems. Hospitals are increasingly using electronic medical records (EMRs), electronic health records (EHRs), electronic patient records (EPRs), computer-based patient records (CPRs), etc. to capture and manage patients' medical and health information electronically. As of 2002, there were five different types of personal health records: (i) off-line personal health record; (ii) web-based commercial personal health record; (iii) web-based functional personal health record; (iv) provider based personal health record; and (v) web-based partial personal health record. Except for the provider based personal health record, all the other types of personal health records were created by the patient or by third parties, not including the health provider. The types and formats of health records have increased exponentially since 2002, and there currently exists myriad, diverse electronic representations of health and medical records from a wide variety of medical systems and other sources.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a healthcare monitoring system for sharing data in a clinical network environment according to an example embodiment;

FIG. 2 is a simplified diagram illustrating example details of an embodiment of the healthcare monitoring system;

FIG. 3 is a simplified diagram illustrating yet other example details of an embodiment of the healthcare monitoring system;

FIG. 4 is a simplified diagram illustrating yet other example details of an embodiment of the healthcare monitoring system;

FIG. 5 is a simplified diagram illustrating yet other example details of an embodiment of the healthcare monitoring system;

FIG. 6 is a simplified diagram illustrating yet other example details of an embodiment of the healthcare monitoring system;

FIG. 7 is a simplified diagram illustrating yet other example details of an embodiment of the healthcare monitoring system;

FIG. 8 is a simplified diagram illustrating yet other example details of an embodiment of the healthcare monitoring system;

FIG. 9 is a simplified diagram illustrating yet other example details of an embodiment of the healthcare monitoring system;

FIG. 10 is a simplified diagram illustrating yet other example details of an embodiment of the healthcare monitoring system;

FIG. 11 is a simplified diagram illustrating yet other example details of an embodiment of the healthcare monitoring system;

FIG. 12 is a simplified flow diagram illustrating example operations that may be associated with an embodiment of the healthcare monitoring system; and

FIG. 13 is a simplified flow diagram illustrating other example operations that may be associated with an embodiment of the healthcare monitoring system.

### DETAILED DESCRIPTION OF EXAMPLE EMBODIMENTS

### Overview

A method for sharing data in a clinical network environment is provided in one example embodiment and includes associating a participant with a community in a clinical network environment comprising patients, medical providers, and payors, determining participant access privileges to data in a database, and providing access to the data according to a predetermined mode of sharing associated with the data. As used herein, the term “clinical network environment” encompasses a network environment configured to process medical data according to statutory and other privacy requirements, for example, according to Health Insurance Portability and Accountability Act (HIPAA). As used herein, the term “community” refers to an implementation of a group having two or more entities (e.g., individuals, organizations such as companies, governments, etc.) between which data can be shared, for example, for improved clinical decisions, research, risk stratification, and information exchange.

The data includes medical data, financial data and operations data associated with patients, medical providers and payors. The predetermined mode of sharing can include pessimistic mode, optimistic mode, or opportunistic mode. According to the optimistic mode, substantially all data in the database is accessible to substantially all participants in the community. According to the pessimistic mode, selected data in the database is accessible to substantially all participants in the community. According to the opportunistic mode, selected customized data in the database is accessible to specific participants in the community.

In specific embodiments, a plurality of communities has access to different portions of the data. In some embodiments, the participant can belong to more than one community. In some scenarios, the participant can be a part of an entity that participates in more than one community. The participant includes at least one client, whose access to the data is set by the participant according to the client's role. The participant's access privileges are set by the community. In some embodiments, the participant's access privileges are determined according to community authentication settings and participant credentials associated with the community and the participant, respectively.

### Example Embodiments

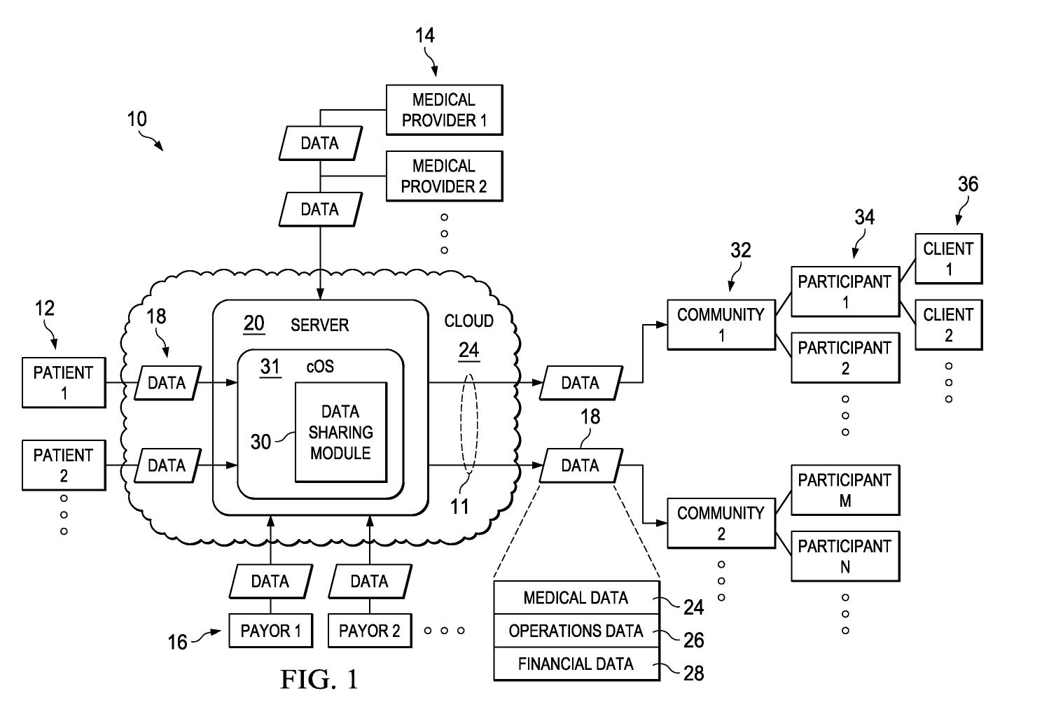

Turning to FIG. 1, FIG. 1 is a simplified block diagram illustrating a healthcare monitoring system 10 for sharing data in a clinical network environment. Healthcare monitoring system 10 includes a clinical network 11 (generally indicated by an arrow) comprising patients 12, medical providers 14 and payors 16 who may communicate data 18 with a server 20 residing in a cloud 22. In a general sense, data 18 refers to any type of numeric, text, voice, video, or script data, or any type of source or object code, or any other suitable information in any appropriate format that may be communicated from one point to another in electronic devices and/or networks. Data 18 may comprise medical data 24, operations data 26, and financial data 28. A data sharing module 30 associated with server 20 and executing on a clinical operating system (cOS) 31 may facilitate sharing data 18 with communities 32 in network 11. Each community may include one or more participants 34. Each participant may include one or more clients 36.

As used herein, the term “medical data” includes information (e.g., facts) related to diagnosis and treatment of a current or potential health condition (e.g., disease, diabetes, obesity, aging, etc.). Medical data 24 for a specific patient includes the patient's health information (e.g., information pertaining to the health of the patient or health care provided to the patient) collected from the patient (or the patient's relatives), including at one or more of medical data sources, such as hospitals, nursing homes, medical centers, clinic, health or nursing agencies, health care facilities, etc. Medical data 24 can include demographic information (e.g., age, weight, gender) that may be relevant to diagnosis and treatment of a current or potential health condition. Medical data 24 may be generated during encounters (e.g., visit at physician's office, laboratory testing, in-home testing). As used herein, the term “patient” refers to an individual who is receiving, or will receive, or has received, medical care and treatment.

Medical data 24 can be associated with (e.g., generated by, derived from, based on, etc.) primary health care services (e.g., care and services provided by a physician and nurse under the direct guidance of a physician) and ancillary services (e.g., supplies and laboratory tests provided under home care, audiology, durable medical equipment (DME), ambulatory surgical centers (ASC), home infusion, hospice care, skilled nursing facility (SNF), cardiac testing, mobile lithotripsy, fitness center, radiology, pulmonary testing, sleep centers, and kidney dialysis). Health care services that generate medical data 24 can include diagnostic (e.g., diagnosis of health conditions and diseases), therapeutic (e.g., treatment of health condition and diseases) and custodial (e.g., care provided by a nursing home or hospital) health care services. By way of examples, and not limitations, medical data 24 can include clinical pathways (e.g., treatment care plan, comprising one or more treatment measures specified to be delivered to the patient according to a predetermined schedule); treatment measures (clinical and other related measures (e.g., events, activities, procedures, actions) provided to (or performed on) the patient); device measurements (e.g., blood pressure monitor measurements, blood sugar measurements, heart rate, etc.); and physician notes during encounters. Other examples of medical data 24 can include registration data (e.g., contact information, social security number), demographics (e.g., date of birth, gender, race), medication and allergies, immunization status, laboratory test results, radiology images, etc.

As used herein, the term “operations data” includes information related to overseeing, designing, and controlling of processes and business operations associated with a medical provider in the course of delivery of medical services. Operations data 26 includes information pertaining to efficiency and effectiveness of business operations and processes that manage converting inputs (e.g., materials, labor, and energy) into outputs (e.g., medical services and related goods). Operations data 26 can include number of employees, resource allocation, employee schedules, resource schedules, energy utilization, resource utilization, etc. associated with delivery of medical services and related goods by the medical provider.

As used herein, the term “medical provider” includes an individual or organization that provides preventive, curative, promotional, or rehabilitative health care services in a systematic way to individuals. Examples of medical providers 14 include health workers, offices of physicians, hospitals, clinics, laboratories, nursing homes, primary care centers, secondary care centers, tertiary care centers, and emergency and urgent care centers. In a general sense, medical care providers are subject to appropriate laws and regulations of political subdivisions (e.g., city, county, state, country) in which they operate.

As used herein, the term “financial data” includes information associated with delivery of medical services and related goods. Financial data 28 includes revenue, profits, costs, and other such financial information associated with running business operations of a medical provider. Financial data 28 can also include payment, reimbursement, liability and other financial information related to delivery of medical services and related goods to patients. For example, financial data 28 can include billing codes, payment made by a patient to the patient's health insurer, and payment made by the health insurer to the medical provider for a specific medical service. Financial data 28 can also include the associated doctor's salary information, costs incurred by the medical provider in delivering the specific medical service, and profit generated by the medical provider. As used herein, the term “payor” refers to an individual or organization that pays (partially or completely) for medical services and related goods that are delivered to patients. Payors 16 can include health insurers, governments, and patients.

For purposes of illustrating the techniques of healthcare monitoring system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

The development of an Information Technology (IT) infrastructure in healthcare delivery has enormous potential to improve the safety, quality, and efficiency of health care and health delivery. Computer-assisted diagnosis can improve clinical decision making. Computer-based reminder systems can improve compliance with preventive service protocols. Immediate access to computer-based clinical information, such as laboratory and radiology results can improve quality of healthcare delivery. Likewise, the availability of complete patient health information at the point of care delivery, clinical decision support systems and other computer-assisted healthcare monitoring systems can prevent many errors and adverse events. In a general sense, patient health information can be shared among all authorized participants in the health care community via secure IT infrastructure

In general, laws such as Health Insurance Portability and Accountability Act (HIPAA) (1996), Health Information Technology for Economic and Clinical Health Act (HITECH) (2009), National Institute of Health Genome Wide Association Studies Policy (2007), European Union Data Protection Directive 95/46/EC, etc. regulate the collection and distribution of patients' medical data to ensure patients' privacy and alleviate related concerns. Challenges to medical data collection and distribution include identifying private data, transforming data to guarantee privacy, quantifying data utility, and publishing the data in view of privacy regulations.

Traditionally, the culture of medical providers, such as hospitals, physician offices, imaging centers, and clinic information systems has been insular; medical data have often resided in separate departments with minimal capability to be interconnected or used with data from other departments, much less other medical providers. Currently existing medical information systems can connect to an array of resources such as billing systems, laboratories, imaging centers, and pharmacies; however, complete patient data abstractions are apparently rarely comprehensive enough to be useful. Moreover, because of medical data privacy rules and regulations, data sharing among disparate medical providers who service the same patient is limited. Patients' access to their own data is limited, and data within individual healthcare facilities remain completely isolated. Clearly, there are distinct advantages in being able to connect the silos of information together and provide seamless data sharing among stakeholders who are associated together for a common cause (e.g., to deliver medical services to one or more patients).

Functional requirements for medical data exchange are far more complex than those used for simple Web-based file exchange to share music, video, and images, such as file exchanges and publishing available on Internet sites like FACEBOOK and YOUTUBE. Examples of functional requirements and technical challenges for an Internet-based system for sharing medical data include: ensuring privacy and confidentiality of data; moving and storing large data files (e.g., radiology images) efficiently and reliably (e.g., lossless communication); aggregating patient knowledge, for example, through construction of registries, which contain knowledge of all fragments of medical information (and their physical location) from all sources for a given patient; matching records and accurately reconciling patient identities; regulating access to data and auditing the access; and aggregating and consuming the data at the point of care. Meeting such functional requirements with no margin for error can involve data sharing systems in the healthcare environment with more complexity to deploy, maintain, and monitor than are traditionally found in simpler social networking sites and other Internet based file exchanges.

Some mechanisms exist in the healthcare environment that can facilitate medical data sharing. For example, CommonWell Health Alliance has a data sharing platform that permits members of the alliance to share patient data with the patient's consent. The system provides a way for healthcare IT suppliers to match patients with their health care records as they transition through care facilities. The system fosters an HIPAA compliant means to share medical data in view of patient's consents and authorizations, and links records across care locations. The patients can manage consents through a patient portal Application Programming Interface (API). The patient consents and directives are stored in a central database. A patient match API and record location API can match a specific patient to corresponding records and retrieve the records appropriately from their respective storage locations in the network. However, the system does not disclose coordinating between disparate member roles (e.g., patients, providers, payors), and moreover, may not provide different access privileges for different participating members.

Healthcare monitoring system 10 is configured to address these issues (and others) in offering a system and a method for sharing data in a clinical network environment. Embodiments of healthcare monitoring system 10 can provide an infrastructure for associating one or more participants 34 with one or more communities 32 in clinical network 11. Data sharing module 20 may determine participant access privileges to data 18 in a database (e.g., provisioned in cloud 24), and providing access to data 18 according to a predetermined mode of sharing associated with the data. The predetermined mode of sharing can include pessimistic mode, optimistic mode, or opportunistic mode. According to the optimistic mode, substantially all data 18 in the database is accessible to substantially all participants 34 in a particular community (e.g., community 1). Optimistic mode may disfavor data sections. According to the pessimistic mode, selected data 18 in the database is accessible to all participants 34 in the particular community (e.g., community 1). Pessimistic mode may favor data sections. According to the opportunistic mode, selected customized data 18 in the database is accessible to specific participants 34 in the community (e.g., community 1). Opportunistic mode may favor scope data (e.g., disparate data grouped together, or customized, according to predetermined attributes; for example, a data element X that is scoped to tasks A, B and C can be freely accessed by the tasks A, B and C, but is not available to tasks D and E) and disfavor non-scope data.

In specific embodiments, communities 32 may have access to different portions of data 18 stored in the database. In some embodiments, participants 34 can belong to more than one community (e.g., community 1 and community 2). In some scenarios, participants 34 can be a part of an entity that participates in more than one community (e.g., community 1 and community 2). In specific embodiments, access to data 18 by clients 36 can be set by the corresponding participant according to the client's role. For example, the chief medical officer of a hospital may have access to a portion of data 18, and the chief financial officer of the same hospital may have access to a different portion of data 18. Moreover, in many embodiments, each participant's access privileges may be set by the community. For example, participant 1 in community 1 may have access to a portion of data 18; participant 2 in the same community 1 may have access to a different portion of data 18. In some embodiments, each participant's access privileges may be determined according to community authentication settings and participant credentials associated with the community and the participant, respectively.

In various embodiments, each community may be identified by a community identifier that can link patients 12, medical providers 14 and payors 16 (among others) across entities. For example, a specific patient 1 may visit medical provider 1 on a routine basis for primary care. Assume that patient 1 visits medical provider 2 for emergency care in a specific instance. Assume that medical provider 1 and 2 are in a community 1 set up and administered by a health insurance company (e.g., payor 1), with whom patient 1 has an insurance policy. According to embodiments of healthcare monitoring system 10, medical provider 2 may access patient 1's data 18 at medical provider 1 through community 1 although medical provider 2 may use an IT infrastructure and system that is incompatible with the IT infrastructure and system of medical provider 1.

Depending on the specific participation extent, each participant may be associated with more than one community identifier. A community enterprise level master patient index (EMPI) may be implemented in some embodiments. Content sharing in some embodiments may be at a folder level, wherein all or nothing of the folder contents may be shared appropriately. For example, folder privacy settings may be specified by the folder owner, and the settings may be suitably associated with the mode of sharing (e.g., optimistic, pessimistic, opportunistic, etc.). The folder level privacy settings may be propagated to substantially all contents of the folder appropriately.

Turning to the infrastructure of healthcare monitoring system 10, the network topology of network 11 can include any number of servers, routers, gateways, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Healthcare monitoring system 10 may include a configuration capable of TCP/IP communications for the electronic transmission or reception of data packets in a network. Healthcare monitoring system 10 may also operate in conjunction with a Client Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of healthcare monitoring system 10. It should be understood that the healthcare monitoring system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, cOS 31 can federate data 18 into a federated centralized database, aggregate data 18 from patients 12, medical providers 14 and payors 16 (among others), convert data 18 from disparate formats to a uniform format (e.g., XML based format), and store data 18 in a suitable data store (e.g., federated centralized database; data store for aggregated data) in cloud 24. cOS 31 may comprise a plurality of self-contained interconnected modules and service layers for connecting proprietary (and public) systems together and extracting and translating data therefrom to enable them to cooperate in a software ecosystem while allowing flexible connections with both existing and new applications.

According to various embodiments, server 20 includes a software program, or a computing device on which the program runs, that provides a specific kind of service to client software running on the same computing device or other computing devices on network 116. Clients 36 may include any electronic device, client, server, peer, service, application, or other object capable of sending, receiving, or forwarding information over a network (e.g., network 11). Examples of clients 36 include computers, laptops, smart phones, printers, etc. Clients 36 may be provisioned with suitable interfaces (e.g., web browsers) that can render data 18, including browser code. In a general sense, clients 36 may provide a client interface, such as a graphical client interface (GUI), and perform some or all of the processing on requests it makes from server 20, which maintains data 18 and processes the requests. For ease of illustration, only one server 20 and a few clients 36 are illustrated in the FIGURE. Virtually any number of servers and clients may be included in healthcare monitoring system 10 within the broad scope of the embodiments.

In some embodiments, data sharing module 30 may be an application installed on server 20 located in a network (e.g., cloud 24) remote from patients 12, medical providers 14 and payors 16. As used herein, the term “application” can be inclusive of an executable file comprising instructions that can be understood and processed on a computer, and may further include library modules loaded during execution, object files, system files, hardware logic, software logic, or any other executable modules. In other embodiments, data sharing module 30 may be installed on server 20 located in the same local area network as patients 12, medical providers 14 and/or payors 16. In some embodiments, data sharing module 30 may be installed on a single computer or server; in other embodiments, data sharing module 30 may be a distributed application residing on a plurality of devices, including virtual machines. Various hardware and software implementations are possible for data sharing module 30, all of which are encompassed within the broad scope of the embodiments.

Patients 12, medical providers 14 and payors 16 can enter data 18 into healthcare monitoring system 10 through various computers, measuring instruments, public and proprietary software applications and systems and such other hardware and software components that facilitate operating with myriad medical data sources and communicating data 18 with cloud 24. Such systems may present various disparate operating systems and platforms to server 20, including EMRs, hospital information systems (HIS), lab and pathology systems (LIS), imaging systems (PACS, RIS), pharmacy systems, scheduling systems, medical devices, etc. In some embodiments, each medical data source may be a separate system, with its own computer network, data format and proprietary applications. In other embodiments, substantially all medical data sources may be part of a single system (e.g., enterprise network, software, etc.) that can interface with each other and with healthcare monitoring system 10.

Cloud 24 is a collection of hardware and software forming a shared pool of configurable computing resources (e.g., networks, servers, storage, applications, services, etc.) that can be suitably provisioned to provide on-demand self-service, network access, resource pooling, elasticity and measured service, among other features. Cloud 24 may be deployed as a private cloud (e.g., infrastructure operated by a single enterprise/organization), community cloud (e.g., infrastructure shared by several organizations to support a specific community that has shared concerns), public cloud (e.g., infrastructure made available to the general public), or a suitable combination of two or more disparate types of clouds. Cloud 24 may be managed by a cloud service provider, who can provide subscribers with at least access to cloud 24, and authorization to use cloud resources in accordance with predetermined service level agreements.

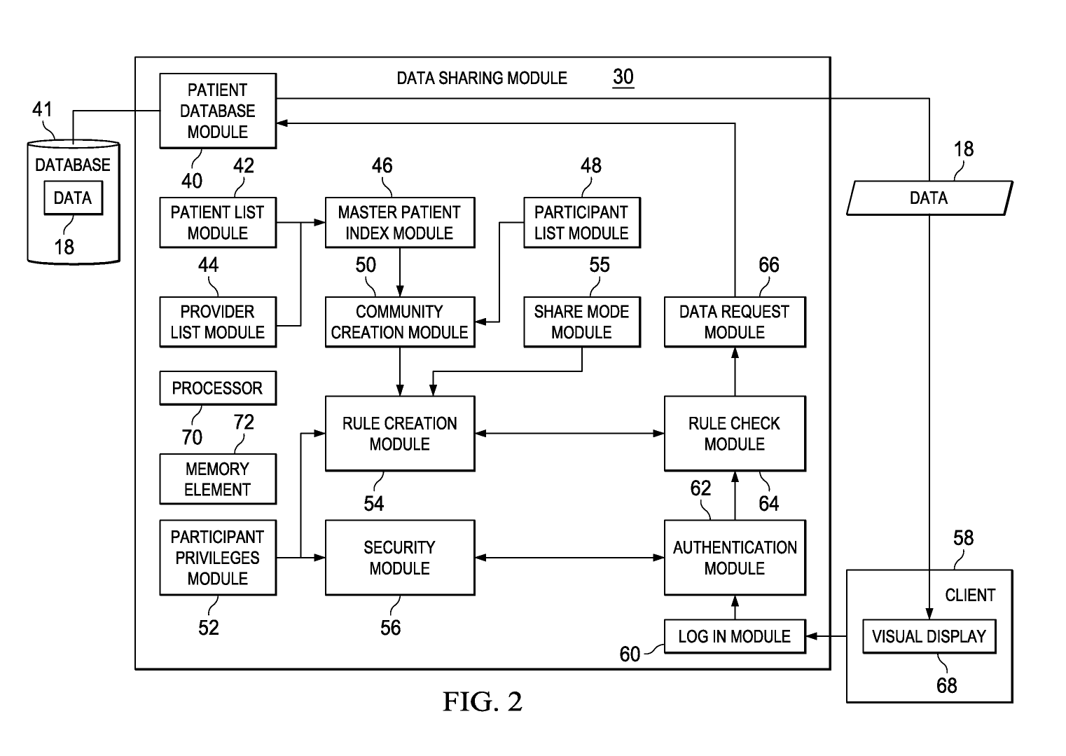

Turning to FIG. 2, FIG. 2 is a simplified block diagram illustrating an example data sharing module 30 according to an embodiment of healthcare monitoring system 10. Data sharing module 30 can include a patient database module 40 that can access a database 41 for storing data 18, a patient list module 42, a provider list module 44, a master patient index module 46, a participant list module 48, a community creation module 50, a participant privileges module 52, a rule creation module 54, and a security module 56. Patient database module 40 may control access to database 41 that stores data 18. Data 18 may be stored in database 41 in any appropriate format, form, table, list, etc., based on particular system needs. Patient list module 42 may include a list of patients 12 whose information may be accessed through healthcare monitoring system 10. Provider list module 44 may include a list of medical providers 14 who may provide services to patients 12 within the framework of healthcare monitoring system 10.

Master patient index module 46 may aggregate registries from various medical providers 14 (and other sources, if available) to store information such as patient name, date of birth, gender, race, social security number and place of residence alongside the patient's medical history. The master patient index can provide a clear and complete view of an individual patient and also a large-scale view of the demographics that medical providers 14 are working with. Participant list module 48 may include a list of participants 34 in each community, indexed according to suitable criteria, for example, participant name, identifier, and community identifier.

In various embodiments, an administrator may configure data sharing module 30 with the information used by patient list module 42, provider list module 44, master patient index module 46, and participant list module 48. In some embodiments, the information may be entered manually; in other embodiments, the information may be extracted by data sharing module 30 from medical records and related records entered into (or stored in) healthcare monitoring system 10.

Community creation module 50 may create communities 32, for example, by associating participants 34 with specific communities according to predetermined configurations. For example, a community administrator may configure data sharing module 30 with information on which participants 34 belong to which communities 32. In some embodiments, community creation module 50 may interface with participant list module 48 to determine the appropriate participants in communities. In some embodiments, community creation module 50 may generate unique authentication settings for each community. The community authentication settings of a specific community may be applied to all participants 32 in that specific community. Community creation module 50 may also generate participant privilege settings and participant authentication settings based on information from participant privileges module 52. The participant privilege settings and participant authentication settings may be controlled by, or through, participant privileges module 52. The participant privilege settings and authentication settings may be applied to all clients 36 associated with the respective participants. Each participant (e.g., participant 1) in a specific community (e.g., community 1) may have privilege settings and authentication settings different from those of other participants (e.g., participant 2) in the specific community.

Rule creation module 54 may generate access rules for participants 34 in communities 32 according to privilege settings and authentication settings from participant privileges module 52 and a share mode module 55. Share mode module 55 may include a mode of sharing permitted for various portions of data 18 in database 41. The generated rules may include community access rules (e.g., which community is permitted to access which data), participant access rules (e.g., which participant is permitted to access which data) and user access rules (e.g., which user is permitted to access which data). Security module 56 may include participant access privileges and authentication settings from participant privileges module 52 in an authentication or security procedure.

During operation, an example client 58 may enter log-in credentials (e.g., username, password, passcode) into healthcare monitoring system, for example, through a web based portal. A log-in module 60 in data sharing module 30 may receive the log-in credentials. An authentication module 62 may interface with security module 56 and determine if the log-in credentials match the authentication settings for participants 34. If there is a match, rule check module 64 may check the rules to determine which data 18 can be accessed by client 58. A data access request may be generated by data request module 66, which may send the request to patient database module 40. Patient database module 40 may retrieve the requested data 18 from database 41 and send it to client 58, where it may be displayed suitably on visual display 68. Data sharing module 30 may use processor 70 and memory element 72 to perform the operations described herein.

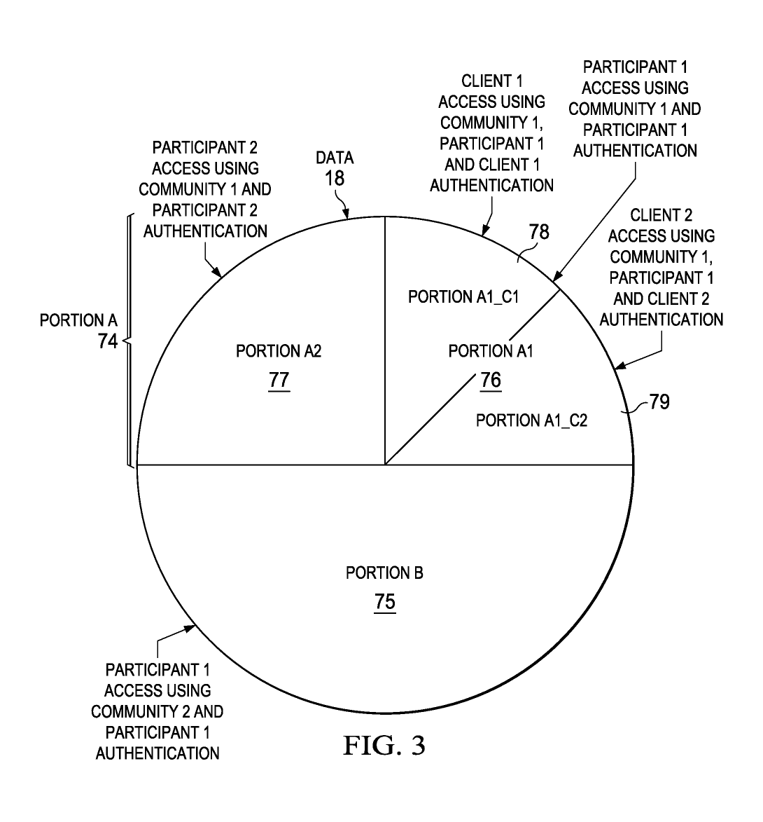

Turning to FIG. 3, FIG. 3 is a simplified block diagram illustrating example details of an embodiment of healthcare monitoring system 10. For example purposes, assume that participant 1 participates in community 1 and community 2; and participant 2 participates in community 1 exclusively. Community 1 may have access to portion 74 (portion A) of data 18; community 2 may have access to a different portion 75 (portion B) of data 18. Assume that participant 1 has access to portion 76 (portion A1) of portion A, and participant 2 has access to a different portion 77 (portion A2) of portion A. Assume also that client 1 belonging to participant 1 can access portion 78 (portion A1_C1) and client 2 belonging to participant 1 can access portion 79 (portion A1_C2). Participants 1 and 2 may have a community specific authentication credential to access community 1. However, participants 1 and 2 can have separate and distinct participant authentication settings into community 1. Participant 1 may have a different set of community specific authentication credential to access community 2. Likewise, clients 1 and 2 may have a client specific authentication credential to access their respective portions of data 18.

When client 1 logs into a portal to access healthcare monitoring system 10, a first level of authentication settings may include logging into community 1's access space. A second level of authentication settings may include logging into participant 1's access space. A third level of authentication settings may include logging into client 1's access space. In client 1's access space, portion 78 of data 18 may be accessible to client 1. Similarly, client 2 may proceed through three levels of authentication settings to reach client 2's access space, where portion 79 of data 18 can be accessed.

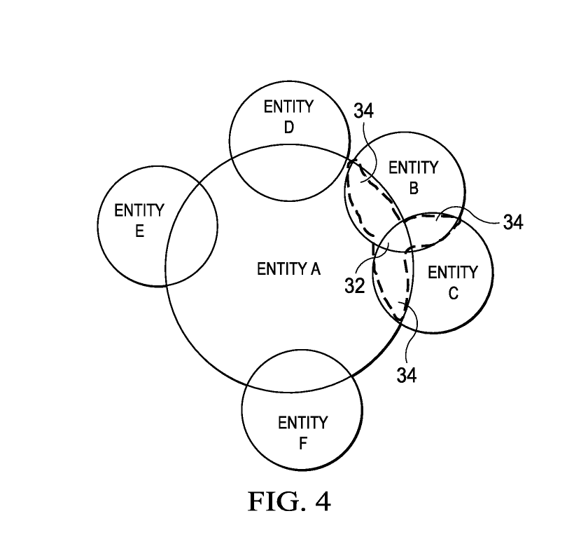

Turning to FIG. 4, FIG. 4 is a simplified diagram illustrating an example community 32 generated from a plurality of entities A-F according to an embodiment of healthcare monitoring system 10. An “entity” can include an individual or organization (e.g., enterprise, business, government agency, etc.). In the illustrated example, entity A may be a payor (e.g., insurance company) working in conjunction with one or more medical providers (e.g., entities B-F). Community 32 may be generated by associating a first portion of entity A, a second portion of entity B and a third portion of entity C together. Portions of entity A, B and C that form part of community 32 may constitute participants 34. Portions of entity A, B and C that are not part of community 32 may not access data available to participants 34. Such division of access may be effected within each participant separately, or by community administrators, as appropriate.

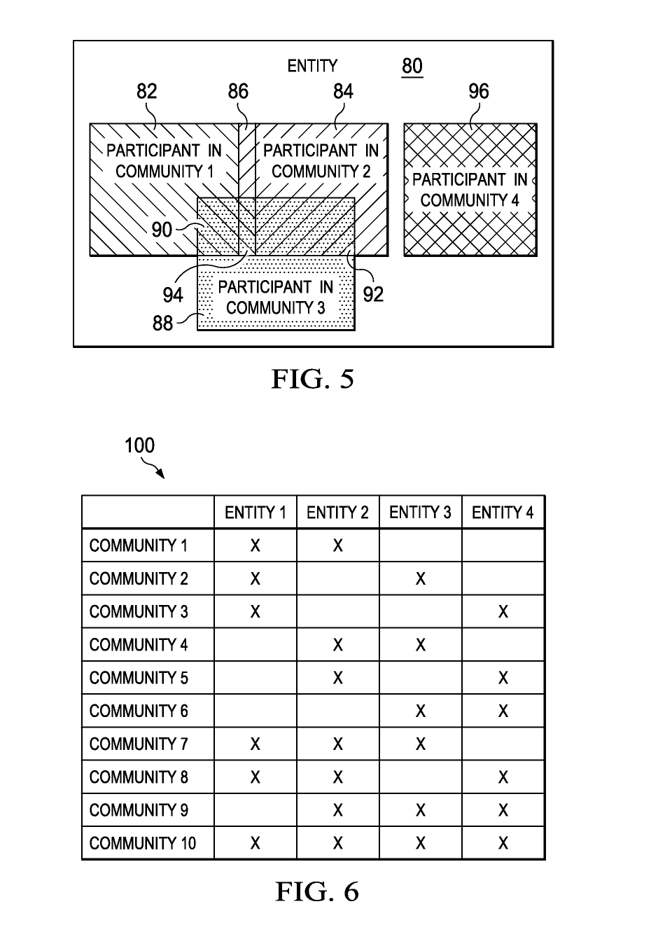

Turning to FIG. 5, FIG. 5 is a simplified diagram illustrating an example entity 80 according to an embodiment of healthcare monitoring system 10. Entity 80 may include various portions that form participants in one or more communities. For example, portion 82 may be a participant in community 1 exclusively. Portion 84 may be a participant in community 2 exclusively. Portion 86 may be a participant in communities 1 and 2 only. Portion 88 may be a participant in community 3. Portion 90 may be a participant in communities 1 and 3 only. Portion 92 may be a participant in communities 2 and 3 only. Portion 94 may be a participant in communities 1, 2, and 3. Portion 96 may be a participant in community 4 exclusively, and so on.

Turning to FIG. 6, FIG. 6 is a simplified diagram illustrating examples of communities formed from various entities according to an embodiment of healthcare monitoring system 10. Table 100 indicates a matrix of entities 1, 2, 3 and 4 that are participants in one or more communities 1-10. For example, entity 1 may be a participant in communities 1, 2, 3, 7, 8 and 10. Entity 2 may be a participant in communities 1, 2, 5, and 7-10. Each entity may choose to participate in one or more communities based on particular business and other needs. For example, entity 1 may be a medical provider that services patients who are members of a specific insurance company, namely entity 2. The patients may also commonly use entity 3 as an emergency medical provider. Entity 1 may choose to participate in a community comprising entities 2 and 3. By participating in the community, entity 1 may have access to patient data serviced by entity 3, thereby enabling better medical decisions and clinical outcomes, by way of examples.

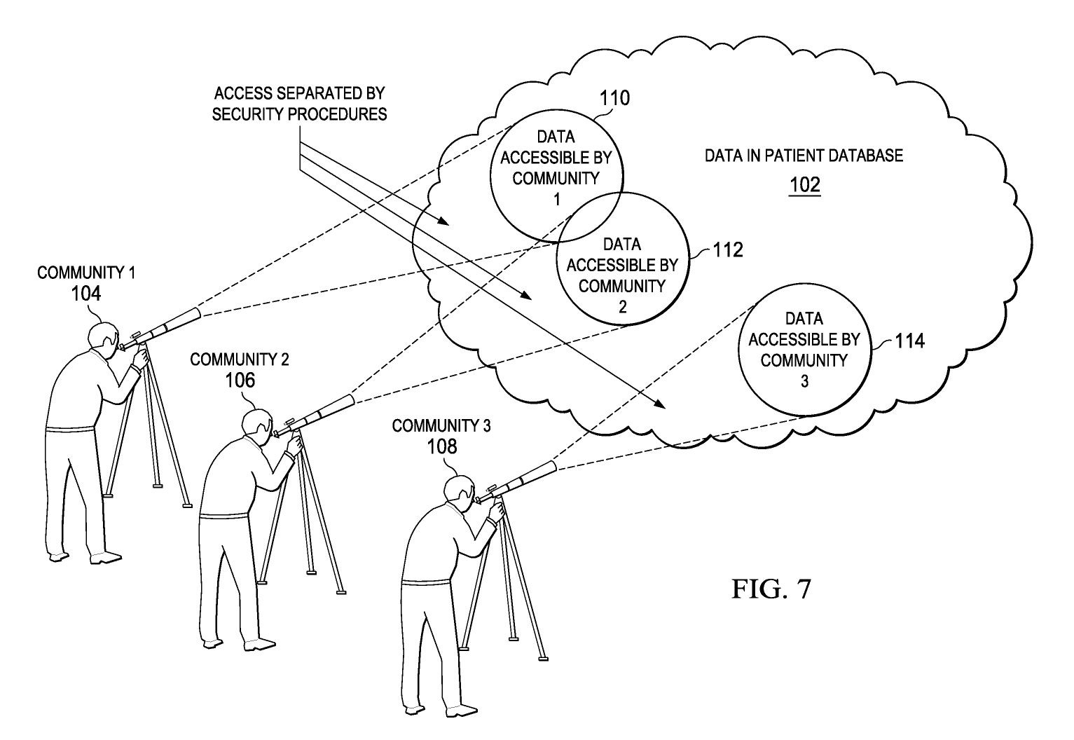

Turning to FIG. 7, FIG. 7 is a simplified diagram illustrating example details according to an embodiment of healthcare monitoring system 10. Portions of data 102 in the patient database (e.g., database 41) may be accessed by participants in various communities 104-108. For example, participants in community 104 may access portion 110 in data 102; participants in community 106 may access portion 112 in data 102; and participants in community 108 may access portion 114 in data 102. Portions 110 and 112 may overlap; however, participants in community 104 may not access data in portion 112 that is outside the overlapped portion. Access by various communities may be separated by appropriate security procedures (e.g., authentication settings such as log-in credentials, etc.).

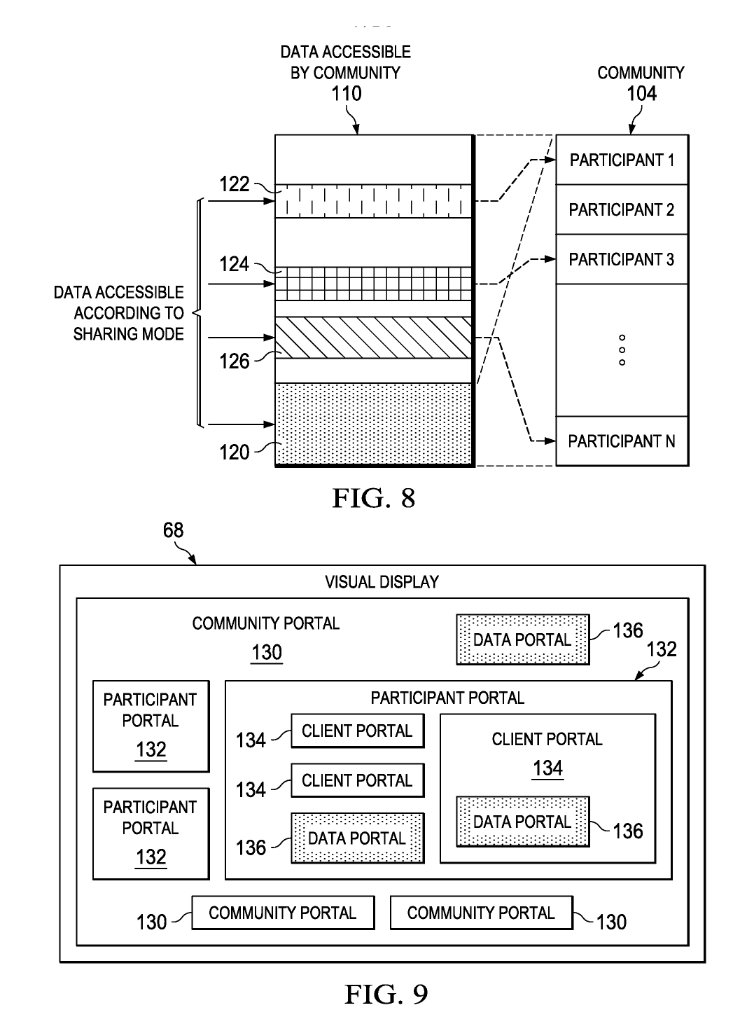

Turning to FIG. 8, FIG. 8 is a simplified diagram illustrating example details according to an embodiment of healthcare monitoring system 10. Data in the patient database (e.g., database 41) may be accessed by various participants according to the respective participant's privileges and the data's sharing mode. For example, substantially all participants can access portion 110 of data in the patient database (e.g., database 41; referring also to the example of the previous figure) according to an optimistic sharing mode. On the other hand, according to a pessimistic sharing mode, a selected portion 120 may be accessed by substantially all participants in community 104. In an opportunistic sharing mode, customized portions 122, 124 and 126 (among others) may be accessed by a select few participants, for example, participant 1, participant 3 and participant N, respectively. In some embodiments, the few participants who can access data in the opportunistic mode may be selected according to the respective participant's access privileges. Various other sharing modes may also be included within the broad scope of the embodiments.

Turning to FIG. 9, FIG. 9 is a simplified diagram illustrating an example visual display 68 according to an embodiment of healthcare monitoring system 10. Visual display 68 may include one or more community portal(s) 130. Each community portal 130 may include one or more participant portal(s) 132. Each participant portal 132 may include one or more client portal(s) 134. Each client portal 134 may include a data portal 136 wherein the data accessible to the respective client may be displayed. In some embodiments, data portal 136 may be accessible within participant portal 130, for example, where the data is shared uniformly across all clients of the respective participant. In some embodiments, data portal 136 may be accessible within community portal 136, for example, where data is shared according to the optimistic mode with substantially all participants in the community. In another example, where selected data is shared according to the pessimistic mode, the selected data may be viewed in data portal 136 within community portal 130.

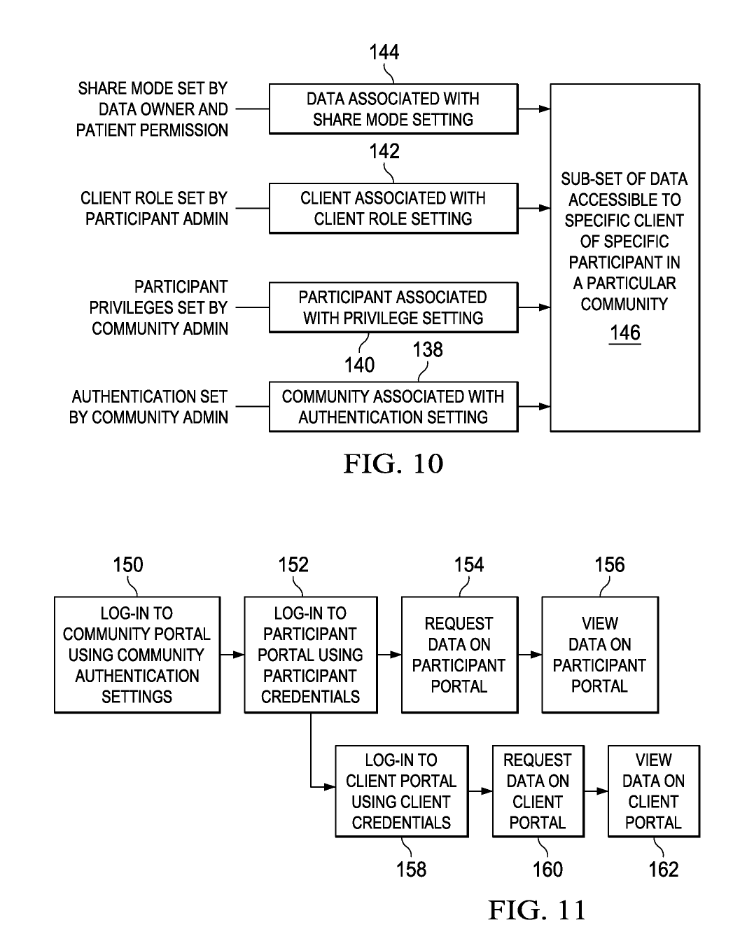

Turning to FIG. 10, FIG. 10 is a simplified diagram illustrating example details of data sharing according to an embodiment of healthcare monitoring system 10. According to detail 138, each community 32 may be associated with an authentication setting that can identify the specific community. The authentication settings may be set by a community administrator. According to detail 140, each participant may be associated with a privilege setting, which may be set by the community administrator. For example, the payor participant may have privileges to view substantially all the financial data in the patient database (e.g., database 41), and no privileges to view selected medical data. On the other hand, the medical provider participant may have privileges to view substantially all medical data in the patient database (e.g., database 41), and no privileges to view selected financial data. In some embodiments, the participant privilege settings may be configured according to the level of participation by the respective participant. For example, the participant may opt to participate only to the level of sharing patient medical data, while refusing access to the participant's operational data. Any level of participation may be included and associated with appropriate privilege settings according to the broad scope of the embodiments.

According to detail 142, each client within a particular participant may be associated with a client role setting, which may be assigned or configured by the participant administrator. In some embodiments, the client role settings may be transparent to the community. For example, the community's participant privilege access settings may permit substantially all clients of the participant to access data available to the respective participant. However, the data may be restricted by the participant to specific clients within itself according to the client's roles. In another example embodiment, the client's access privileges may be set by the community administrator according to the specifications (e.g., access rules, etc.) provided by the respective participant.

According to detail 144, data 18 may be associated with a share mode setting, set by the data owner and patient permission. For example, data accessed by a particular community may be owned by one of the participants in the community. The data owner may set the share mode appropriately (e.g., pessimistic, optimistic, opportunistic). In some embodiments, the data may be owned by a specific participant, but may relate to a patient's private medical information. Access to such data may be controlled according to the patient's permissions in addition to the data owner's share mode settings. According to the data sharing mode, patient permissions, client roles, participant privileges and community authentication settings, as illustrated in detail 146, a sub-set of data 18 may be accessible to a specific client of a specific participant in a particular community.

Turning to FIG. 11, FIG. 11 is a simplified diagram illustrating example operations that may be associated with embodiments of healthcare monitoring system 10. At 150, a user may log-in to community portal 130 using community authentication settings. At 152, the user may log-in to participant portal 132 using participant credentials (e.g., authentication settings such as username, password, etc.). At 154, a request for data may be submitted on participant portal 132. At 156, the requested data may be viewed on participant portal 132, for example, on data portal 136. Alternatively (or additionally), the user may log-in to client portal 134 using client credentials (e.g., username, password, etc.) at 158. At 160, a request for data may be submitted on client portal 134. At 162, the requested data may be viewed on client portal 134, for example, on data portal 136.

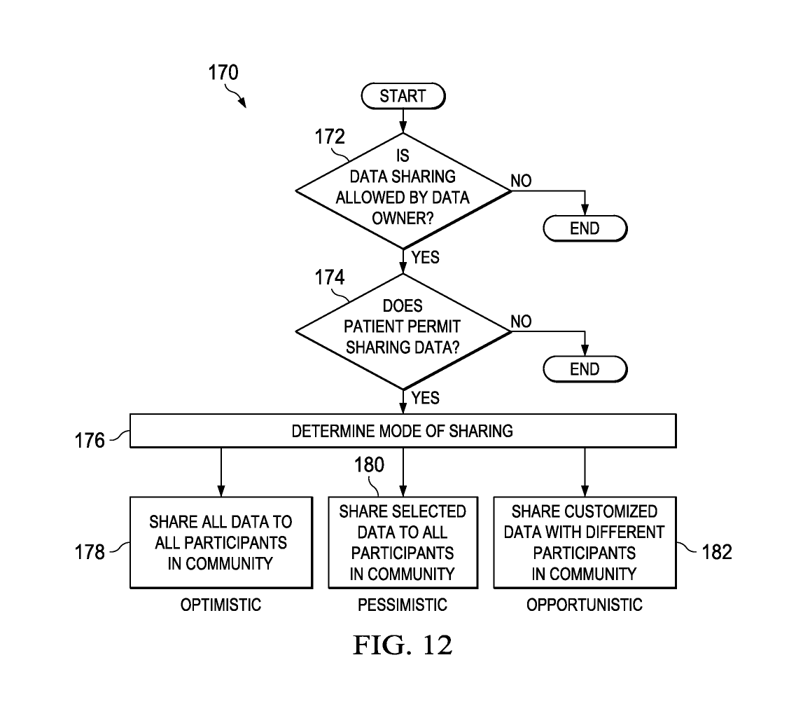

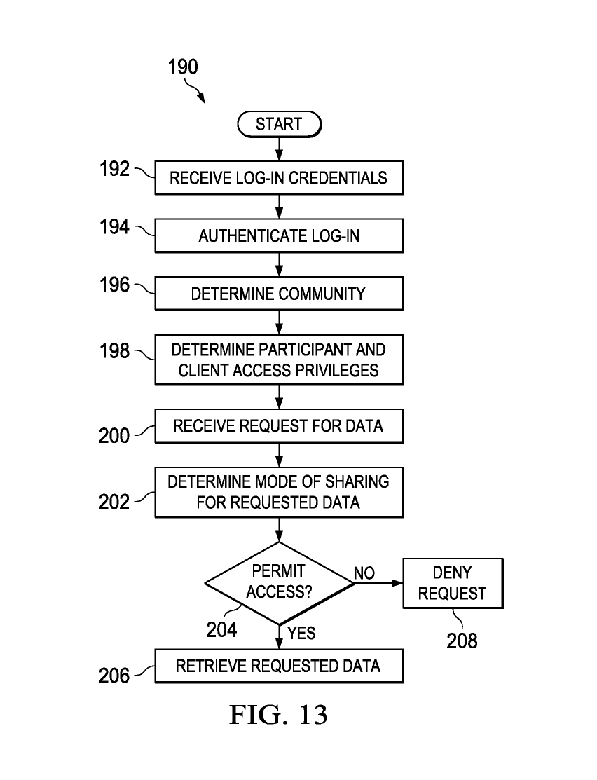

Turning to FIG. 12, FIG. 12 is a simplified diagram illustrating example operations 170 that may be associated with embodiments of healthcare monitoring system 10 when a data request is received. At 172, a determination may be made whether the data is permitted to be shared by the data owner. If not, the request for data may be denied and the operations may end. If data sharing is permitted by the data owner, at 174, a determination may be made whether the patient permits sharing the patient's data. If not, the request for data may be denied and the operations may end. If data sharing is permitted by the patient, at 176, the mode of sharing may be determined. If the mode of sharing is optimistic, substantially all data may be shared with substantially all participants in the community at 178. If the mode of sharing is pessimistic, select data may be shared with substantially all participants in the community at 180. If the mode of sharing is opportunistic, customized data (e.g., scoped data) may be shared with different participants in the community at 182

Turning to FIG. 12, FIG. 12 is a simplified diagram illustrating example operations 190 that may be associated with embodiments of healthcare monitoring system 10. At 192, log-in credentials (e.g., username, password, pincode, pass-key, etc.) may be received at healthcare monitoring system 10. At 192, the log-in credentials may be authenticated (e.g., through appropriate security procedures, such as a checking the credentials, security certificates, etc.). At 196, the community associated with the log-in credentials may be determined. At 198, the participant associated with the log-on credentials may be determined, as also the client access privileges. Note that if the authentication fails at any time, access to healthcare monitoring system 10 may be completely or partially denied.

At 200, a request for data may be received. At 202, a mode of sharing for requested data may be determined. At 204, a determination may be made whether to permit access. If access is permitted according to the community authentication settings, participant privilege settings, client role settings, and data sharing mode, the requested data may be retrieved from the patient database (e.g., database 41) at 206 and displayed on a suitable portal, such as display portal 138. If access is not permitted at 204, the request for data may be denied at 208, for example, with an error message that says “access denied” or other suitable request denial mechanism.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

In example implementations, at least some portions of the activities outlined herein may be implemented in software in, for example, data sharing module 30. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, data sharing module 30 described and shown herein (and/or its associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 72, database 41) can store data used for the operations described herein. This includes the memory element being able to store instructions (e.g., software, logic, code, etc.) in non-transitory media such that the instructions are executed to carry out the activities described in this Specification.

A processor can execute any type of instructions associated with the data to achieve the operations detailed herein in this Specification. In one example, processors (e.g., processor 70) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, components in healthcare monitoring system 10 can include one or more memory elements (e.g., memory element 72, database 41) for storing information to be used in achieving operations as outlined herein. These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs.

The information being tracked, sent, received, or stored in healthcare monitoring system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, healthcare monitoring system 10 may be applicable to other exchanges or routing protocols. Moreover, although healthcare monitoring system 10 has been illustrated with reference to particular elements and operations that facilitate the communication process, these elements, and operations may be replaced by any suitable architecture or process that achieves the intended functionality of healthcare monitoring system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
associating a participant with a community in a clinical network environment comprising patients, medical providers, and payors;
determining participant access privileges to data in a database, wherein the data comprises medical data, financial data and operations data, wherein the data is associated with at least one of a patient, a medical provider and a payor; and
providing access to the data according to a predetermined mode of sharing associated with the data, wherein the predetermined mode of sharing is selected from a group consisting of: pessimistic mode, optimistic mode, and opportunistic mode.

2. The method of claim 1, wherein according to the optimistic mode, substantially all data in the database is accessible to substantially all participants in the community.

3. The method of claim 1, wherein according to the pessimistic mode, selected data in the database is accessible to substantially all participants in the community.

4. The method of claim 1, wherein according to the opportunistic mode, selected customized data in the database is accessible to specific participants in the community.

5. The method of claim 1, wherein a plurality of communities has access to different portions of the data.

6. The method of claim 1, wherein the participant belongs to more than one community.

7. The method of claim 1, wherein the participant is a part of an entity that participates in more than one community.

8. The method of claim 1, wherein the participant's access privileges are set by the community.

9. The method of claim 1, wherein the participant includes at least one client, wherein the client's access to the data is set by the participant according to the client's role.

10. The method of claim 1, wherein the participant's access privileges are determined according to community authentication settings and participant credentials associated with the community and the participant, respectively.

11. Logic encoded in non-transitory media that includes instructions for execution and when executed by a processor, is operable to perform operations comprising:
associating a participant with a community in a clinical network environment comprising patients, medical providers, and payors;
determining participant access privileges to data in a database, wherein the data comprises medical data, financial data and operations data, wherein the data is associated with at least one of a patient, a medical provider and a payor; and
providing access to the data according to a predetermined mode of sharing associated with the data, wherein the predetermined mode of sharing is selected from a group consisting of: pessimistic mode, optimistic mode, and opportunistic mode.

12. The logic of claim 11, wherein according to the optimistic mode, substantially all data in the database is accessible to substantially all participants in the community.

13. The logic of claim 11, wherein according to the pessimistic mode, selected data in the database is accessible to substantially all participants in the community.

14. The logic of claim 11, wherein according to the opportunistic mode, selected customized data in the database is accessible to specific participants in the community.

15. The logic of claim 11, wherein the participant's access privileges are determined according to community authentication settings and participant credentials associated with the community and the participant, respectively.

16. An apparatus, comprising:
a community creation module;
a rule creation module;
a memory element to store data; and
a processor to execute instructions associated with the data, wherein the processor and the memory element cooperate such that the apparatus is configured for:
associating a participant with a community in a clinical network environment comprising patients, medical providers, and payors;
determining participant access privileges to data in a database, wherein the data comprises medical data, financial data and operations data, wherein the data is associated with at least one of a patient, a medical provider and a payor; and
providing access to the data according to a predetermined mode of sharing associated with the data, wherein the predetermined mode of sharing is selected from a group consisting of: pessimistic mode, optimistic mode, and opportunistic mode.

17. The apparatus of claim 16, wherein according to the optimistic mode, substantially all data in the database is accessible to substantially all participants in the community.

18. The apparatus of claim 16, wherein according to the pessimistic mode, selected data in the database is accessible to substantially all participants in the community.

19. The apparatus of claim 16, wherein according to the opportunistic mode, selected customized data in the database is accessible to specific participants in the community.

20. The apparatus of claim 16, wherein the participant's access privileges are determined according to community authentication settings and participant credentials associated with the community and the participant, respectively.
